(19) United States
(12) Patent Application Publication
(10) Pub. No.: US 2020/0018687 A1
(43) Pub. Date: Jan. 16, 2020

(54) ENVIRONMENTAL SYSTEM ON MODULE APPARATUS

(71) Applicant: Clad Innovations Ltd., Pitt Meadows (CA)

(72) Inventors: Vladislav Igorevich Lavrovsky, Vancouver (CA); Kevin Hart, Port Coquitlam (CA)

(73) Assignee: Clad Innovations LTD., Pitt Meadows, BC (CA)

(21) Appl. No.: 16/470,956

(22) PCT Filed: Dec. 18, 2017
(86) PCT No.: PCT/CA2017/000269

§ 371 Date: Jun. 18, 2019

Related U.S. Application Data
(60) Provisional application No. 62/435,839, filed on Dec. 18, 2016.

(51) Int. Cl. G01N 15/14

(52) U.S. Cl. CPC G01N 15/1459; G01N 2015/0046; G01N 15/1404; G01N 15/1434

(57) ABSTRACT

An environmental system on a module apparatus for detecting and measuring particles entrained in an air stream. The apparatus includes a highly-integrated silicon circuit board. The circuit board has a plurality of embedded sensors, signal conditioning and processing. The plurality of sensors to detect pollution and other aspects of the physical environment. The apparatus also including a mechanical structure surrounding the top side of the circuit board. The structure forms an air pathway having an inlet and an outlet and a laser beam pathway having an emitter end and a beam line termination end. The air pathway intersects the laser beam pathway. A highly miniaturized optical particle scattering detector is located proximal to the intersection. A laser is located in the emitter end of the laser beam pathway.

### CROSS REFERENCES TO RELATED APPLICATIONS

This application claims the benefit from U.S. Provisional Application Ser. No. 62/435,839 filed Dec. 18, 2016 entitled Environmental System on Module, the entire contents of which are incorporated herein by reference.

### FIELD OF THE INVENTION

This invention relates generally to detecting pollutants in an airflow.

### BACKGROUND OF THE INVENTION

According to the World Health Organization (WHO), air pollution is now the single largest environmental health risk, with particle pollution being the most impactful on humans. The natural environment and built environments are being modified to improve factors such as air quality that are proven to enhance the occupants' health and wellness. Prior art measurement tools such as real-time monitors are being used to quantify the environment, produce insights, and automate changes. Accordingly, there is a need for effective apparatus to monitoring and tracking environmental conditions that improves the prior art.

### SUMMARY OF THE INVENTION

The present invention provides an improved apparatus to monitoring and tracking environmental conditions.

In one aspect of the present invention, an environmental system on a module apparatus for detecting and measuring particles entrained in an air stream is disclosed. The apparatus including a highly-integrated circuit substrate, the circuit substrate having a plurality of embedded sensors, signal conditioning and processing. The circuit and components within it are the electronics package of the apparatus. The plurality of sensors are capable of detecting pollution and other aspects of the physical environment. A plastic or metal mechanical structure surrounds the top side of the circuit board. The structure forms an air pathway having an inlet and an outlet and a laser beam pathway having an emitter end and a beam line termination end. This mechanical structure forms the physics package of the apparatus. The air pathway intersecting the laser beam pathway. A highly miniaturized optical particle scattering detector is also included and is locate at the intersection of the air pathway a laser beam pathway. This aspect also includes a laser located in the emitter end of the laser beam pathway.

In other aspects, the apparatus may include variations of the placement and size of the components. These variations may include having the air pathway being parallel to the laser beam pathway. Further, the optical particle scattering detector may be set in a position that maximized focal length distance from the emitter. Still further, the air pathway may be configured to allow bidirectional air flow. Still further, the diameter of the air channel may have a tapered shape.

In other aspects, the apparatus may include additional components. These additional components may include an output connector to enable the apparatus as an embedded component into other products. Further, the apparatus may include a wireless radio component to enable wireless transmission of data to and from the apparatus. Still further, the apparatus may include at least one selectively populated sensor to detect more gas-based pollution types. Still further, the apparatus may include a microcontroller or ASIC and/or a band pass filter positioned over the optical particle scattering detector.

### BRIEF DESCRIPTION OF THE DRAWINGS

Further features and advantages of the invention will be apparent from the following description of the embodiment, which is described by way of example only and with reference to the accompanying drawings.

FIG. 1 is a top view of a block diagram of an embodiment of the present invention.

FIG. 2 is a bottom view of a block diagram of the embodiment of the present invention shown in FIG. 1.

FIG. 3 is a side views of a block diagram of the embodiment of the present invention shown in FIG. 1 along line AA.

FIG. 4 is a side views of a block diagram of the embodiment of the present invention shown in FIG. 1 along line BB.

FIGS. 5A-C are block views of embodiments of the laser included within the embodiment of the present invention shown in FIG. 1

FIGS. 6A-B are side views of embodiments of the mechanical structure of the present invention.

FIG. 7 is a top view of a block diagram of an additional embodiment of the present invention.

FIG. 8 is a side views of a block diagram of the embodiment of the present invention shown in FIG. 7 along line CC.

FIG. 9 is a top view of an embodiment of the photodiode of the present invention.

FIG. 10 is a top view of an additional embodiment of the photodiode of the present invention.

FIG. 11 is a block diagram of an embodiment of the placement of sensors within the air pathway of the present invention.

FIG. 12 is a perspective view of an embodiment of the electronics component of the present invention.

The accompanying drawings are included to provide a further understanding of the present invention and are incorporated in and constitute a part of this specification. The drawings illustrate some embodiments of the invention and together with the description serve to explain the principles of the invention. Other embodiments of the invention and many of the intended advantages of embodiments of the invention will be readily appreciated, as they become better understood by reference to the following detailed description. The elements of the drawings are not necessarily to scale relative to each other. Like reference numerals designate corresponding similar parts.

### DETAILED DESCRIPTION OF THE INVENTION

The present invention provides an provides an improved apparatus to monitoring and tracking environmental conditions.

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalents; it is limited only by the claims.

A System on a Module (SoM), or Computer on Module (CoM) is a board level circuit that integrates a system function in a single module. It may integrate digital and analog functions on a single board, e.g. mixed-signal integrated circuit. A typical application of a SoM is in the area of embedded systems. Unlike a single board computer, SoM serves a special function like a System on Chip (SoC). The device integrated on the SoM typically requires a high level of interconnection for reasons such as speed, timing, size constraints, bus-width etc., in a highly-integrated module.

There are benefits in building a SoM, such as the reduced cost of the base board or the main printed circuit board. A major advantage of SoM is design-reuse and that it can be integrated into many embedded computer applications. The SoM may contain one or more SOC or System in Package (SiP) subsystems that integrate multiple devices into readily reconfigurable elements. The subsystems are defined by the ability to aggregate elements that are physically proximal and can be produced by the same semiconductor manufacturing processes.

In a general embodiment of the present invention, an environmental SoM (ESoM) is disclosed. This embodiment as two main components, namely, an electronics component comprising a highly integrated circuit on a variety of substrates and a physics component comprising an engineered material that is mated to the electronics component. The circuit substrates may be a composite of multiple materials or numerous layers of the same material and may be made from various material, including but not limited to glass, FR-2, FR-4, Teflon, polyimide, PEEK; while the engineered material may be made from metal or plastic.

In one embodiment, the ESoM is a highly-integrated circuit board with embedded sensors, signal conditioning and processing, e.g. mixed-signal IC. The ESoM contains a set of sensors meant to detect pollution and other aspects of the physical environment. The ESoM achieves continuous capture of all key air quality parameters through its plurality of sensors. Pressure, humidity, and temperature are measured, not only for ambient readings, but to compensate for environmental factors known to adversely affect optical methods of detecting particles.

This embodiment contains a highly miniaturized optical particle scattering photodetector with a low impedance air channel for passive or externally pumped air displacement through the ESoM sensor cavity. A mechanical structure surrounds the top side of the circuit substrate to form the air pathway having an inlet and an outlet, and the light pathway having an emitter end and a beam line termination end. The mechanical structure may be made from various material, including but not limited to metal or plastics, including plastics that are compatible with 3D molded interconnect device (MID) fabrication processes, e.g. PCABS, PBT, PC, PEEK, PPA, PPE and LCP.

The two pathways may be perpendicular to each other, with sensors located in the air pathway. The photodetector is located at a position proximal to the intersection of the two pathways, set in a position that achieves the desired beam line cross section relative to the focal length of a light emitter. The photodetector may be in a 90 degree configuration where a photodiode is directly under the photodetector, which are non-complicated to manufacture. Additionally, a photodiode may be in frontal position relative to the photodetector, which provided higher signal strength and are easier to use for particle sizing.

A light emitter, such as a laser, is located within the emitter end and projects a beam of light through the light pathway. The light beam may be highly divergent, which allows tuning of the cross section or spot size of the detection volume. This allows the detector to have higher sensitivity to small particles by use of a small spot size across the detector or a larger sampling volume by use of a larger spot size. For example, one device may utilize a beam size that has a higher detection of very small particles while a second device may utilize a beam size the samples a larger fraction of the air passing through the ESoM.

These sensors may be highly integrated, die-bonded into a SoC, on the same silicon and wafer, with potential sensor combinations including temperature, relative humidity, pressure, air velocity, gas mass flow, photodetector, total volatile organic compounds (tVOC), formaldehyde, nitrous oxide, carbon dioxide, carbon monoxide and other gases. This embodiment may have an I2C and an SPI bus or other connection method for data output. This enables use of the ESoM as an embedded component into other products, such as ductless split-type units, e.g. HVAC air handling/cleaning appliance, or into an enclosure as a stationary or mobile stand-alone product. The ESoM component may output data to a wireless radio, short range radios such as BLE, Wi-Fi may be used. The apparatus may also utilize long range radios such as cellular, or any LPWAN radio such as LoRa, SigFox, LTE-M or NB-IOT may be used, where data packets are passed to a cloud connected system that updates device drift compensation and environmental calibration values. The apparatus may have multiple radios to communicate to local devices such as routers, hubs and smartphones in parallel with distant access points such as cellular base stations. The short range radio may have a specialized purpose such as commissioning and provisioning, or may be used to deliver telemetry directly or propagated by a mesh network to local consumers.

This embodiment may allow for air to flow unilaterally or bidirectionally through the device, and may have the diameter of the air channel within the ESOM device with a tapered or nozzle shape or alternatively a consistent diameter (i.e. untapered) across the device. The nozzle feature is understood to include tapering in any axis, or multiple axes simultaneously. The tapering is gradual, to reduce turbulence and losses due to collision of particles with the physics component. The tapering may also have undulations that act as baffles to ambient or otherwise external stray light. There may be one or more undulation features along the air pathway, to attenuate stray light and improve optical SNR. Further, this ESoM may have a selectively populated sensor, such as NOx sensor to detect more gas-based pollution types. Still further, this embodiment may include a microcontroller or ASIC and/or a band pass filter over the detector.

The inclusion of a highly miniaturized optical particle scattering photodetector requires complex geometry to achieve size discrimination, high detection efficiency and low contamination in a small size. The geometry must ensure laminar air flow, high attenuation of both ambient and internal stray light, high tolerances on alignment of optics, high dimensional stability and complex reflective surfaces for gathering lights from a wide range of angles. This must be achieved while maintaining low impedance to air flow as high displacement is necessary to have high sensitivity and a low response time.

This embodiment of the ESoM has two main components, an electronics package and a physics package that is tightly coupled to the electronics package. The electronics package contains the emitters and receivers of electromagnetic radiation used to detect the particles or aerosols in the air stream sampling path. The electronics package may also contain amplifiers to add gain to the signal, signal conditioning electronics, signal processing electronics, microcontrollers and signal interfaces to allow communication over physical or wireless channels. The physics package manages airflow, stray light, collects desired light, and positions the detection elements relative to each other.

In an embodiment, the use of molded interconnect device (MID) fabrication allows the physics package to contain emitters, receivers, attenuators and reflectors in any position relative to one another, greatly improving the available design freedom. The MID fabrication utilizes injection-molding techniques to create an injection-molded thermoplastic part with integrated electronic circuit traces. This technology combines plastic substrate/housing with circuitry into a single part by selective metallization. The utilization of the MID process allows this embodiment to have high precision plastic components that have integral reflective and conductive features.

The metallization of the desired surfaces of the embodiment is used in areas to produce electrical traces similar to a PCB, this allows mounting emitters and receivers at angles other than 90 degrees to the plane of the electronics. This allows configurations of the ESoM which maximize the signal using forward or backward scattering that dominates the optical signal of certain ranges of particle diameters and refractive indexes. While the angles best suited for detection of small particles in the range of 1-10 um with laser of visible wavelengths are well established, the fabrication of small, high performance, low maintenance detectors is not currently know in the art.

This embodiment utilizes the MID process to create detection elements that are embedded within the physics package. The geometry of the physics package may include spheroid cavities. These spheroid cavities may be metalized in the same manner as the traces to the electronic components. There is a variety of methods that can be used to metalize the spheroid cavities. One such method used with the traces, and optical surfaces, are structured using the action of a laser. The laser modifies the surface mechanically or chemically, depending on the work substrate composition. The laser may roughen the surface or may carburize the surface. The laser may ablate the surface which can expose underlying material of a different composition or may release embedded chemicals. The work substrate, when in the form of an injection molded plastic, may have additives that are activated by heat or exposure to the atmosphere. All of these treatments allow for subsequent seeding by metalization precursors or may directly allow metalization or plating. The plating process may need to be prolonged, to ensure that any roughness in the work substrate is resolved, so that the optical surfaces have a low RMS surface roughness. Alternatively, the surface can be post-processed to achieve the required surface roughness or optical performance. Post processing may be a polishing operation or can be a hot stamping process. A heated tool of the correct negative of the optical feature may be used to selectively melt the optical surface either before or after plating. A thermoplastic work substrate allows re-structuring of the surfaces prior to plating, alternatively the plated surfaces can be heated to alter the surfaces. High surface quality is not required, but improves signal quality.

The spheroid optical cavities are formed to collect light at very specific ranges of angles, depending on the quality of the beam line, the angles vary. Smaller numbers of angles are collected by the optical cavities when using a laser that has a lower quality, such as a laser that is not the ideal top-hat or Gaussian form. The optical cavities must allow the beam line to exit or terminate in a beam-dump or beam stop. How close the reflective, collecting surfaces come to the edge of the beam stop, beam dump or beam escape geometry is a function of the particular laser being utilized in the electronics package, by varying the clearances and the number of angles, the optical cavity can be tuned to maximize SNR. In this way, the emitter performance is not required to be very high and emitters with lower beam quality can still be effectively used in the ESoM.

The detectors may be in either the electronics package or the physics package, or may be in both. Multiple detectors are used when there is sufficient bandwidth and processing available in the electronics package or in ancillary electronics that the electronics package is connected to. Multiple detectors improve size discrimination because the plurality of angles relative to the angle of the excitation beam line allows disambiguation of the relationship between the signal amplitude and the size of the particle being detected. This embodiment may utilize a plurality of detectors, or optics that collect a large number of scattering angles or a combination to achieve this disambiguation of particle size.

When the detectors are in the physics package, they may be embedded below the surface of the material, thus the parts may be co-planar with the surrounding material. This allows improved resistance to contamination. Alternatively, the use of optically clear inserts allows light to propagate and reach the detector while not allowing disturbance of the airflow. The detection cavity, which may be spheroidal in shape, may have an optical component of glass of plastic that matches the three dimensional shape of the cavity. It may be thought of or be in the form of a lens. It is useful to consider the shape of a plano-convex lens, where the flat side of the lens is proximal to the air pathway and the convex portion is inserted into the detection cavity. In this way, the air stream is not disturbed by the presence of the cavity. Alternatively, the cavity may be filled through an epoxy filling or other polymerization process after formation of the cavity. The cavity may also be filled by multi-material injection molding.

In some embodiments, the electronics component of the ESoM may be assembled using various substrate materials including but not limited to FR2, FR4, polyimide, Teflon, PEEK glass or ceramic. These embodiments may be successfully constructed using any substrate. In certain applications, there is a need to fabricate the ESoM using glass substrates. The glass substrate reduces the effect of exposure to the environment, which is advantageous in environments with large swings in temperature and humidity or prolonged exposure to condensing humidity. While an FR4 material is hydroscopic and is prone to being laden with moisture, even when suitably encapsulated with conformal coatings, a glass substrate is dimensionally stable and non-hydroscopic even under challenging conditions such as deployment outdoors. This removes many sources of drift and error in critical components like voltage references, high performance amplifiers and the optics.

The ESoM must operate in a wide variety of conditions and is exposed to large variations in temperature and humidity along with prolonged contact with macro and microscopic aerosols and particles. The aerosols or particles may be charged, or may be laden with moisture, resulting in high adhesion to surfaces, furthermore, once deposited, may form nucleation sites resulting in accelerated loading of the surfaces. The loading of surfaces has numerous negatives outcomes for a sensor system resulting in loss of SNR, false negatives as well as drift in one or more channels of data. All channels of data are prone to changes in repeatability, stability and drift due to operating time, oxidization, thermal cycling and exposure to moisture, amongst other mechanisms. This can be via occlusion of optics, either emitters or receivers, occlusion of air-exchange apertures in gas-phase sensors, ageing or poisoning of active surfaces such as metal-oxide sensing elements. There are numerous interventions utilized to maximize the stability of the accuracy and precision of the apparatus over time. The inventive ESoM is resistant to these error sources using mechanical, material and electrical interventions.

The ESoM may use one or more of these interventions depending on the configuration of the electronics and physics packages. The ESoM has an air pathway that has minimal obstructions, it thus has a low impedance to airflow and does not contribute to the turbulence of the air within the package. This ensures that the displacement through the ESoM can be maximized, this has numerous effects, most notably that the signal quality is higher and that aerosols stay in suspension rather than be deposited. Signal quality is higher because a greater fraction of the air in the operating environment is actually sampled by the apparatus, this is true in both passive and actively driven configurations. Given a fixed source of air movement, be that ambient air currents or the action of a fan or pump, the large and straight cross section of the ESOM air pathway allows the maximum displacement possible.

The air pathway may be a rectangular pathway of the majority of the width of the ESoM body, with a variable height. Different physics packages may be produced with a variety of thickness to produce a stack-up compatible with small or large host devices. The air pathway may have a constriction or choke along its length, this allows the concentration of the aerosol across the detection region. This forced particles into a tighter area, allowing the optical particle detector to detect a greater fraction of the particles that enter the ESoM. This increases the detection efficiency or detection probability of the ESoM. This constriction or choke may also be used to accelerate the air stream, this acceleration prevents heavy particles from settling out of the air and contaminating the apparatus. The constriction or choke may have a very gradual change in cross-section to prevent turbulence and avoid losses to do particle collisions with the walls of the physics package that form the air pathway.

The air pathway may also be a cylindrical aperture in the center of the ESoM, the same constriction or choke may be present. The construction or choke may be centered, or may be elongated, with the nozzle like feature at the inlet and outlet and a straight section through the sensing region.

The components in the electronics package present an opportunity for increased turbulence in the air stream and have many surfaces prone to accretion of particles. Thus minimizing their cross section improves the longevity of the apparatus. The ESoM may have numerous layers in the electronics package, this allows the individual components to be mounted within the substrate at various levels. Each plane or layer of the electronics can have the component embedded within it. Components that are do not need to be exposed to the air stream are buried within the substrate or are placed on the opposite side of the substrate, away from the airstream. The ESoM substrate may have 2,4, 6, 8 or more layers in the electronics package, each of those is an individual mounting plane. The substrate has apertures conforming to the shape of the components, allowing them to be placed in the cavities and connected electrically to the interconnect formed by the metal on those layers. By matching the components to layers based on their height and by selecting the thickness of the substrate, especially the thickness of the bulk separators, the components can be made to be roughly or exactly co-planar with one another or with the substrate surface. If the components are co-planar with the substrate surface, then no further processing is required, if they are not however, an additional component may be placed to fill the voids. This may be a feature of the physics package or a separate metal or plastic component or may be formed by a liquid that can be polymerized. This may be an epoxy or other polymer hardened by its own self-catalyzing chemistry, heat, UV or other curing process. In this way, a co-planar surface can be achieved.

Stray light is common and may introduce error in any optics present in the ESoM, especially those used in the detection and quantification of aerosols such as particulate matter. This is challenging due to the small size of the ESoM and the necessity of the large aperture for air ingress. The ESoM may have the following composition to reduce the impact of stray light. The air stream may have surfaces that attenuate light by dies, pigments or other dark materials that absorb light. The physics package may be dark in color, typically a black thermoplastic is used that effectively absorbs light. The packaging of the light detectors and sensors are critical, they may utilize a package that has opaque walls on three sides to prevent ingress of light through the sides of the package. They may also be recessed into the substrate to achieve the same shielding on the edges. The light sensors may be photodiodes, and they may have a package where the top of the package is a bandpass material. Alternatively a cover glass of bandpass material may be placed over top the photodiode or light sensor. The cover glass can be affixed using any process known to someone skilled in the art of electronics manufacturing including bonding using adhesives especially UV-cured optical adhesives or may be held in place by bonding the bandpass filter to adjacent components or the electrical substrate itself

The bandpass filter absorbs light in a broad range of wavelengths to either side of the excitation wavelength, the wavelength or wavelengths produced by the emitter or emitters. The bandpass filter may by plastic or glass that is modified with chemical dopants or made or specific materials that intrinsically have the necessary spectral response. The width of the pass band, the thickness of the material and thus its level of stray light attenuation is variable, depending on the intended application. Typically the excitation wavelength are in the visible wavelength of 390-700 nm, thus the bandpass filter must pass some portion of that spectrum while maximizing attenuation of unused wavelengths. The bandpass filter greatly reduces the DC offset and shot-noise experienced by the optics. Thus the need for external optical baffles or other light management features is reduced, simplifying integration of the ESoM into a host device and allowing it to be integrated into smaller form-factor hosts.

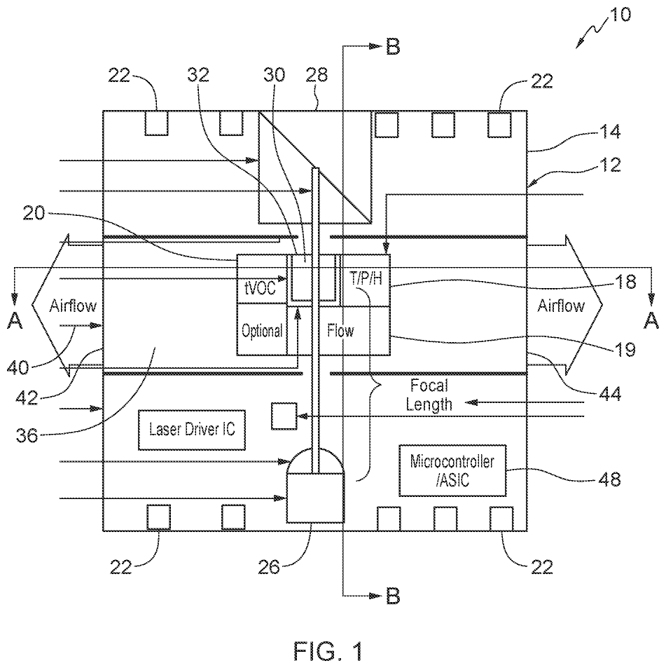

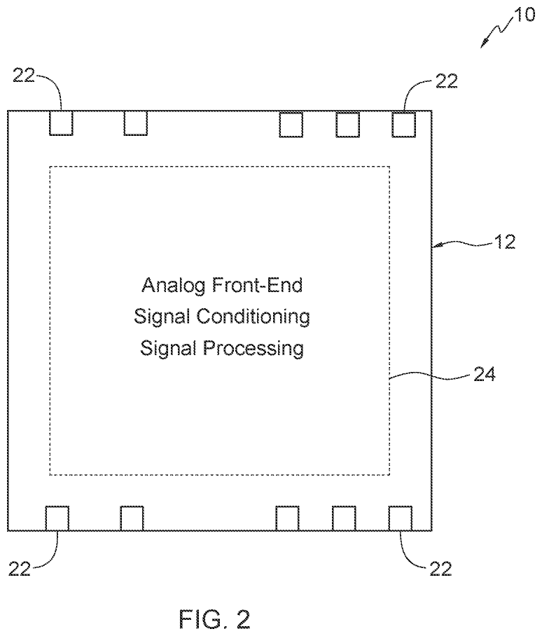

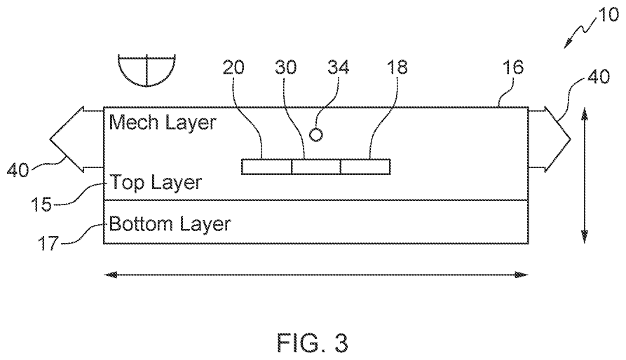

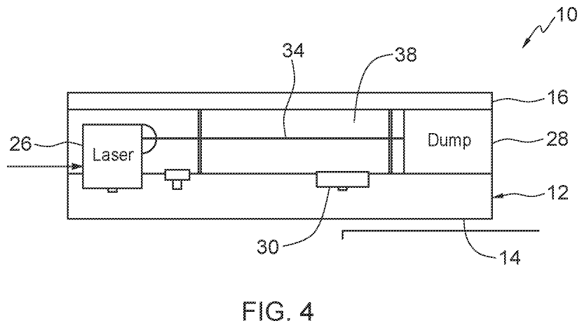

FIGS. 1-4 illustrate an embodiment of an ESoM apparatus 10 for detecting and measuring particles entrained in an air stream. Apparatus 10 includes an electronics component comprising a highly integrated circuit 12 on a variety of substrates 14 and a physics component comprising an engineered structure 16, which also may be referred to as a mechanical structure, that is mated to the electronics component. The circuit substrates 14 may be made from glass, while the engineered material may be made from metal or plastic.

Circuit substrate 14 has a plurality of components to detect the composition and physical properties conditions of the air and other aspects of the physical environment. In this embodiment, the components include various sensors that are highly integrated into the ESoM, including sensors to measure temperature, pressure and humidity sensors 18, an air flow sensor 19, along with total volatile organic compounds (tVOC) 20.

These sensors 18-20 are integrated directly into the circuit substrate 14 with direct die bonding. This optimizes use of wafer real estate which lowers production costs. Further, the tighter integration also shrinks the size of the sensor footprint. Additionally, due to a small surface area, the sensors are closer to each other. This results in more reliable sensor results as the likelihood the sensors are sensing the same sample of air, e.g. spatial, and detecting the same sampling at the same time, e.g. temporal.

A laser package 28 and a beam dump 30 are located on the circuit substrate 14. Laser package 28 may be a packaged edge emitter diode with an increased standoff height to achieve the intended beam height over the photodetector 26 laser package 28 may also be a vertical cavity laser that is packaged at a right angle to the surface and at the intended beam height over the photodetector 26. Laser package 28 directs a light beam 34 toward being dumped 30. A photodetector 30 is positioned along the path of light beam 34. In this embodiment, the focal length between the laser package 28 in the center of the photodetector 30 should be as large as possible in order to maximize performance factors ranging from particle sizing accuracy to particle counting resolution. This is due to the intrinsic divergent angle of the laser beam 34, and the desire to collimate the laser beam 34 to achieve a sufficient raleigh length over the photodetector 30 for consistent measurement and to optimum beam intensity to cross-sectional area across the photodetector 34.

In this embodiment, a microcontroller 21 or ASIC and contact pins 22 may be included. Contact pins 22 are spaced across substrate 14. Contact pins 22 provide a data input/output connection with other electronic components along with access to a power source. Further, in this embodiment, analog front end signal conditioning and signal processing components are located within substrate 14.

In this embodiment, engineered structure 16 is mated to a top layer 15 of substrate 14 and forms an air pathway 36 and a light pathway 38. Air pathway 36 has an inlet 42 and outlet 44 to allow an air stream 40 to pass there through. Light pathway 38 has an emitter end 46 and a beam line termination end 48. Laser package 26 is located within emitter end 46. Beam dump 28 is located within beam line termination end 48. Air pathway 36 is configured to intersect with light pathway 38. This allows the light passing through the intersection to intersect with the air stream causing the light to be scattered. Photodetector 30 is located at this intersection. When the light is scattered, photodetector 30 collects the scattered light. Further, the various sensors are capable to taking various measurements of the air stream 40. A plurality of components, including a microcontroller 48, process the collected scattered light and sensor data.

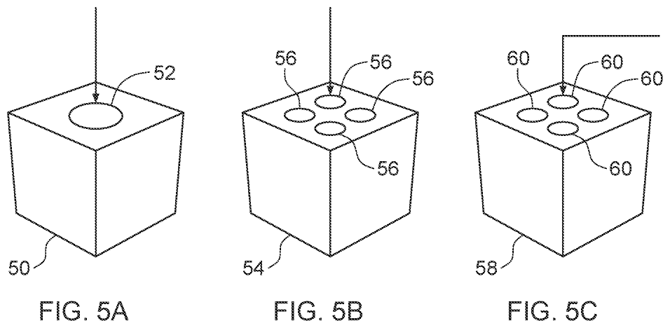

FIGS. 5A-C illustrate embodiments of laser package 26. FIG. 5A illustrates an embodiment of a laser emitter 50 having a single aperture 52. FIG. 5B illustrates an embodiment of a laser emitter 54 having a plurality of apertures 56. In this embodiment, each aperture 56 is a laser having the same wavelength, which results in greater beam power. The laser array or matrix can be collected with micro-lenses combining optics, ball lens, or effervescent wave coupling. FIG. 5C illustrates an embodiment of laser emitter 58 having a laser array or matrix having a plurality of apertures 60. In this embodiment, each individual aperture 60 may be of a different diameter and with a different internal stack up structure, representing a different wavelength emitted. This enables laser emitter 54 to have multiple wavelengths of excitation simultaneously. Combined with multiple wavelength selective photodiode channels, this allows measurement of particle characteristics such as an index of refraction and albedo.

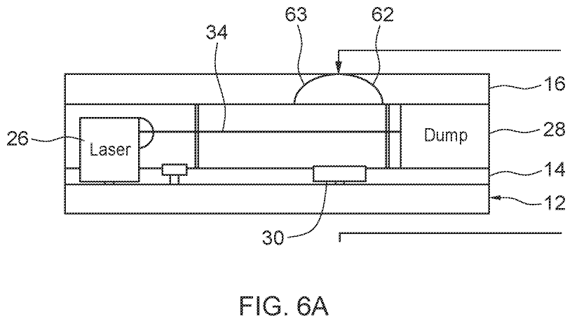

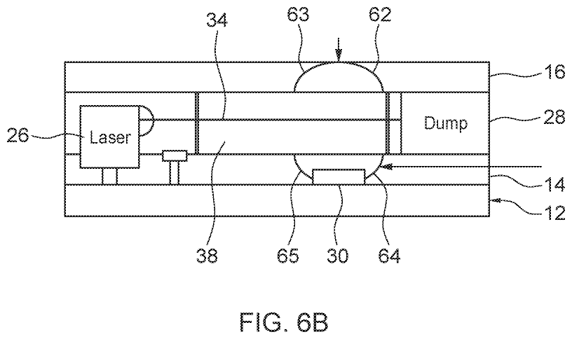

FIGS. 6A-B illustrate embodiments of the engineered structure 16. FIG. 6A illustrates an embodiment of engineered structure 16 having a reflective surface 63 arranged in a spheroid shape 62 and located above photodetector 26. Reflective surface 63 captures scattered and/or reflected laser beam light in the upper directions from the laser beam light and redirects this light onto photodiode 26 below. FIG. 6B illustrates an additional embodiment of engineered structures 16 having the reflective surface 63 located above photodetector 26 and having a spheroid shaped reflective surface 64 located below light beam 34. Reflective surface 65 allows for the capturing of scattered and reflected light 34 in the lower directions from light 34 and redirects the light onto photodiode 26 above.

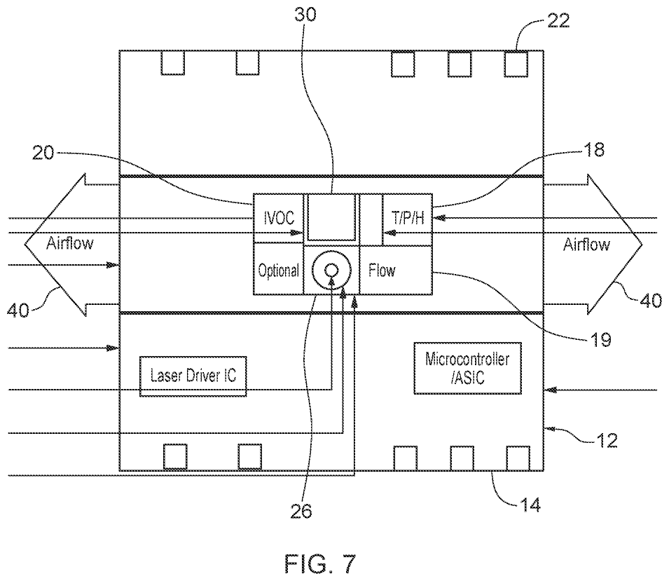

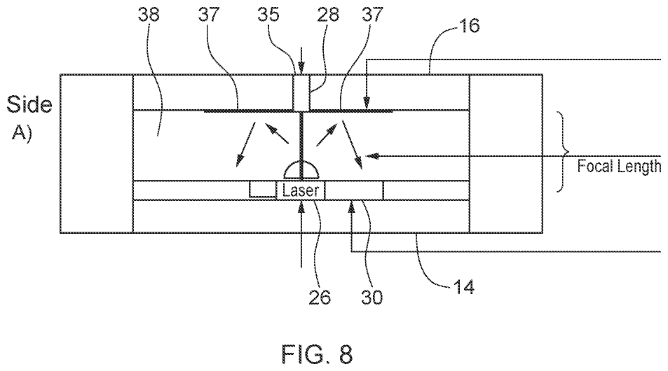

FIGS. 7-8 illustrate an additional embodiment of the ESoM apparatus. In this embodiment, the axis of the laser is perpendicular rather than parallel to the surface of circuit substrate 14. This allows all components of this embodiment to be fabricated in a single plane, greatly increasing package density and reducing process steps. In this embodiment, the laser beam dump 28 is above the plane of the sensors. Laser beam dump 28 is surrounded by a reflective layer 37 that reflects any laser light 34 that does not enter a small aperture 35 of the beam dump 28. Accordingly, the only light that can avoid beam dump 28 is the light that is reflected or scattered by the transit of particulates through photodetector 30.

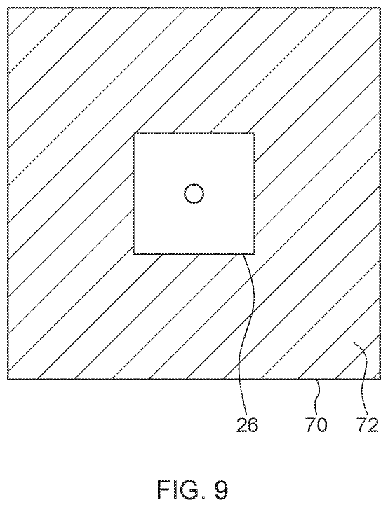

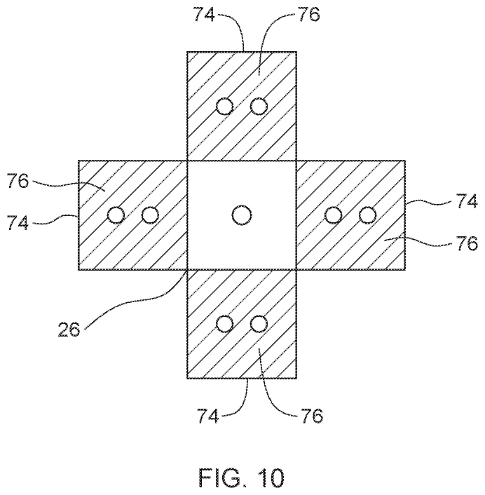

FIGS. 9-10 illustrate embodiments of the photodetector 26. FIG. 9 illustrates an embodiment of photodetector 26 having a single photodiode 70 having a bandpass filter 72 associated therewith. Bandpass filter 72 ensures that the photodetector 70 is only sensitive to a narrow bandwidth of wavelengths, where the bandwidth is selected to match the wavelength of laser package 26. Further, the laser package 26 may be assembled in the center of photodiode 70 ensures high capture of the reflected light from the reflective layer. FIG. 10 illustrates an embodiment of photodetector 26 having a plurality of photodiodes 74. Surrounding each photodiode 74 is an associated bandpass filter 76, where each bandpass filter 76 having a different wavelength to selectively respond to a particular range of wavelengths. Further, the laser package 26 may be assembled in the center of photodiodes 74 ensures high capture of the reflected light from the reflective layer. Each photodiode 70, 74 may be a large monolithic photodiode having a single channel and single wavelength.

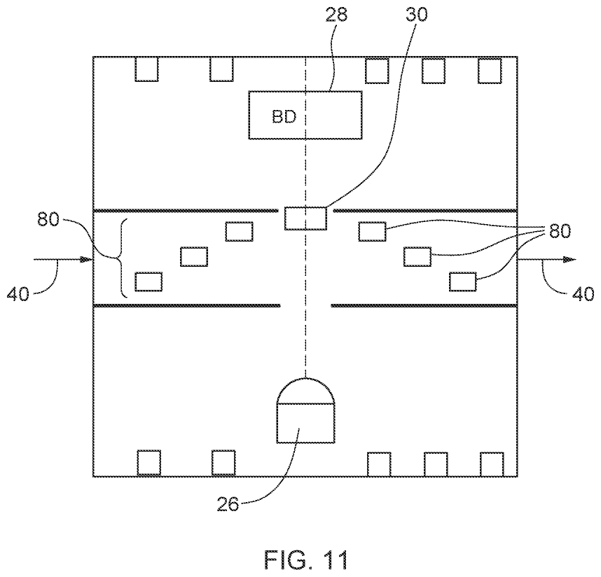

FIG. 11 illustrates an additional embodiment of the placement of various sensors 80 within the airflow pathway 36 in relation to the light path 38. The various sensors 80 may be located on either side of photodetector 30. The various sensors 80 may be are also located offset from each other such that the placement of various sensors 80 may cover substantially all of the width of airflow pathway 36; this ensures that substantially all of airflow 40 will be capable of being analyzed and measured.

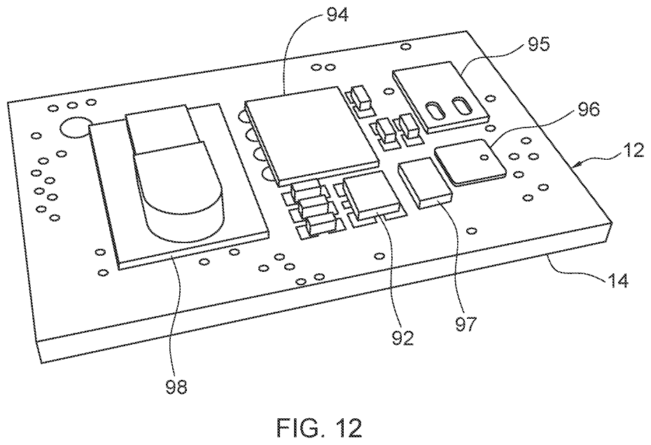

FIG. 12 illustrates an embodiment of circuit 12 having various components located thereon. As shown, circuit 12 includes a circuit substrate 90 having a laser beam source 92 and a photodiode receiver array 94 located in the center of circuit substrate 90 A VOC sensor 95, temperature/humidity/pressure sensor 96 and a gas phase sensor 97 are located on one side of beam source 92. A flow sensor 98 is located on the opposite side of beam source 92. This configuration of the various components is illustrative and is not meant to be limiting. Those skilled in the art will recognize that additional configurations of the electrical components on the circuit substrates 90 is within the scope of the present invention.

In other embodiments, at least one electrical component is exposed to the air stream. These components are located on internal layers of the circuit substrate 14 relative to their individual thickness. This allows for a more compact size of the apparatus.

In other embodiment, at least one flow sensor and circuit substrate 14 are co-planar to reduce boundary layer effects of the air flow. This minimizes the sedimentation and/or other accretion of particles or other contaminants, and stabilize flow sensor measurements.

In other embodiments, a wireless radio component is included to enable wireless transmission of data to and from the apparatus. Further, in other embodiments, the air pathway 36 is configured to allow bidirectional air flow and the diameter of the air pathway 36 may have a tapered shape.

In other embodiments, circuit substrate 14 may be constructed from a transparent material, such as glass. In these embodiments, a reflective material may be located on the transparent substrate, wherein the light pathway is configured to act as a waveguide.

In other embodiments, the physics package may include a low impedance air path, a 3D tapering in the air path to accelerate airstream through detector, spheroid collecting surfaces and/or infill of cavities in the physics package with lenses, cast polymer or injection molded material.

In other embodiments, the molded interconnect device (MID) fabrication process may produce light emitters and detectors being surface-mounted in the physics package, light emitter and emitters embedded in the physics package co-planar with surrounding material and/or the formation of reflective/collecting surfaces directly on physics package surface.

In other embodiments, the glass substrate may include an emitter/detector pair with beam line parallel to the plane of the electronics package, rather than perpendicular; integrated optical wave guides; beam line isolated from environment until it reaches the detection volume; and/or stable operation of the analog front end due to low infiltration of moisture into the substrate.

While the invention has been described with a certain degree of particularity, it is manifest that many changes may be made in the details of construction and the arrangement of components without departing from the spirit and scope of this disclosure. It is understood that the invention is not limited to the embodiments set forth herein for purposes of exemplification.

Numerous specific details have been set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

What is claimed:

1. An environmental system on a module apparatus for detecting and measuring particles entrained in an air stream, the apparatus comprising:
a highly-integrated circuit having a circuit substrate, the circuit substrate having a plurality of components to detect composition and/or physical properties of the air and other aspects of the physical environment, the components include embedded sensors and signal conditioning and processing components;
a mechanical structure surrounding the top side of the circuit board, the structure forming an air pathway having an inlet and an outlet to allow an air stream to pass therethrough, the structure forming a light pathway having an emitter end and a beam line termination end, the air pathway intersecting the light pathway;
a highly miniaturized optical particle scattering detector located at the intersection; and at least one light source located in the emitter end of the light pathway directing light along the light pathway toward the beam line termination end, the light passing through the intersection and intersects with the air stream wherein the light is scattered,
wherein the detector collects the scattered light and wherein the plurality of components process the collected scattered light.

2. The apparatus of claim 1, wherein the plurality of components further comprises at least one flow sensor located in the air pathway.

3. The apparatus of claim 1, wherein each of the components that are exposed to the air stream are located on internal layers of the circuit substrate relative to their individual thickness.

4. The apparatus of claim 2, wherein the at least one flow sensor and circuit substrate are co-planar to reduce boundary layer effects of the air flow and to minimize the sedimentation and/or other accretion of particles or other contaminants, and stabilize flow sensor measurements.

5. The apparatus of claim 1, wherein the air pathway is perpendicular to the laser beam pathway.

6. (canceled)

7. The apparatus of claim 1, wherein the light source is a laser having a single aperture.

8. The apparatus of claim 1, wherein the light source is a plurality of lasers having a plurality of apertures.

9. (canceled)

10. The apparatus of claim 8, wherein the light from the plurality of apertures are distributed across the air pathway to increase the cross-sectional area of the light to air interface.

11. (canceled)

12. (canceled)

13. The apparatus of claim 1, wherein the mechanical structure includes at least one reflective surface arranged in a spheroid shape and located above the optical particle scattering detector.

14. The apparatus of claim 1, wherein the mechanical structure is formed using a molded interconnect device processes.

15. The apparatus of claim 1, further comprises an output connector to enable the apparatus as an embedded component into other products.

16. The apparatus of claim 1, further comprises a wireless radio component to enable wireless transmission of data to and from the apparatus.

17. The apparatus of claim 1, wherein the air pathway being configured to allow bidirectional air flow.

18. The apparatus of claim 1, further comprises selectively populated sensors to detect gas-phase pollution.

19. The apparatus of claim 1, further comprises a microcontroller or ASIC.

20. The apparatus of claim 1, wherein the geometry of the air channel has a tapered shape.

21. The apparatus of claim 1, further comprises one or more optical band pass filters of one or more wavelength ranges over the optical particle detector.

22. (canceled)

23. (canceled)

24. The apparatus of claim 22 further comprising reflective material located on the transparent substrate, wherein the light pathway is configured to act as a waveguide.

25. The apparatus of claim 22 further comprising an aperture in the substrate such that the air stream pathway is perpendicular to the axis of the circuit substrate.

26. The apparatus of claim 1, wherein the mechanical structure further comprises at least one optical surface formed directly on the material of the mechanical structure and is integral to the form of the mechanical structure.
